(19) United States
(12) Patent Application Publication
(10) Pub. No.: US 2020/0331254 A1
(43) Pub. Date: Oct. 22, 2020

(54) METHOD FOR PRODUCING AND RECYCLING AN OBJECT CONSISTING OF A PANEL DURABLY PROVIDED WITH A SURFACE COVERING

(71) Applicant: DSM IP ASSETS B.V., Heerlen (NL)

(72) Inventors: Jan Henderikus UDDING, Echt (NL); Eric LOGTENS, Venlo (NL); Alwin PAPEGAAIJ, Echt (NL); Jelle Bernardus Otto VAN DER WERF, Echt (NL); Maria Anna Francisca JACOBS, Schoten (BE)

(21) Appl. No.: 16/763,347

(22) PCT Filed: Nov. 20, 2018
(86) PCT No.: PCT/EP2018/081991

§ 371 Date: May 12, 2020

(30) Foreign Application Priority Data
Nov. 22, 2017 (EP) 17203171.8

(51) Int. Cl. B32B 43/00; B32B 7/12; B32B 21/02; B32B 21/04; B32B 37/12

(52) U.S. Cl. CPC B32B 43/006; B32B 7/12; B32B 2037/1215; B32B 21/042; B32B 37/1207; B32B 21/02

(57) ABSTRACT

The present invention pertains to a method for producing and recycling an object consisting of a panel durably provided with a surface covering, comprising bringing the panel and the surface covering in a spatially aligned relationship, providing a layer of hot melt adhesive between the panel and the surface covering, heating the hot melt adhesive to a temperature above its melting temperature, pressing the surface covering against the panel with the molten hot melt adhesive in between the panel and surface covering, cooling down the hot melt adhesive to a temperature below its melting temperature to form the object, and after an end-of-life of the object, heating the hot melt adhesive to a temperature above its melting temperature, and separating the panel from the surface covering. The invention also pertains to a method of producing such an object and a panel for use in this method.

### GENERAL FIELD OF THE INVENTION

The invention is directed to the design of a panel durably provided with a surface covering, e.g. a decorative and/or functional covering, while at the same time enabling a re-use of the panel after its end-of-life. In other words, the invention pertains to a so-called design for re-use in the area of decorative and structural panels.

### BACKGROUND

In the manufacture of furniture, cabinets, household articles, counter tops, floor and wall decorations and the like, it is known to use panels to which a surface covering such as a laminate is provided in order to provide for a functional and decorative surface. The surface covering typically consists of a sheet material that is adhered to one or more of the planar portions of the panel. The surface covering provides for an aesthetic and durable use of the panel. In recent years, a lot of attention has gone to developing sustainable laminates for covering panels which led i.a. to the development of new types of high pressure laminates (HPL, produced by saturating multiple layers of kraft paper with phenolic resin), thermally fused laminates (TFL, wherein a resin-impregnated sheet of décor paper is fused directly to a panel), new types of decorative papers and foils (mostly pre-impregnated with a blend of melamine, acrylic and urea resins) and new types of rigid thermoformable foils (RTF, thermoplastic 2D and 3D coverings). Also, a lot of development has gone into finding alternatives for wood as a resource for making panels. Panels made of the fibrous residue of sugarcane, beets, grain, or panels made of paper waste, stone, recycled and recovered wood materials etc. have been described in the art, aiming at a design that has a lower impact on the availability of natural resources.

Little attention has been given to the recycling of the panel after its end of life by separating the panel from its surface covering. Although there is an apparent need for such separation, the attention has been directed to obtaining a functional, durable and strong bond between the panel and its surface covering, instead of to the possibility of separating the panel from its surface covering. Indeed, in practice the types of adhesives used lead to a strong permanent connection between the panel and its covering. Typical types of adhesives are thermosetting, thermoplastic and contact adhesives. Thermosetting adhesives cure at room temperature or in a hot press by chemical reaction, to form a network of rigid bonds (crosslinks) that are not re-softened by subsequent exposure to heat. The most commonly used are urea-formaldehyde adhesives, resorcinol and phenol-resorcinol adhesives. Thermoplastic adhesives harden at room temperature through loss of water or solvent and re-soften upon subsequent exposure to heat. The most commonly used are polyvinyl acetate adhesives (white glue) and catalyzed polyvinyl acetate adhesives. Contact adhesives can be water- or solvent-based and are suitable for bonding laminates to most substrates. They must be applied to both mating surfaces and dried before bonding. Laminating can be accomplished at room temperature. High strength, water-resistant bonds are developed almost immediately upon contact between both coated surfaces. The glue line remains flexible, allowing the surface covering to expand and contract independently of the substrate, which minimizes the tendency of the finished panel to warp.

Recycling of panels durably provided with a surface covering typically takes place by shredding the panels, form a (mixed) particulate material and use this material to form new sheet shaped material (see e.g. US 20140075874). However, the new material, due to the mixed content of panel material and surface covering material, is typically of a lower quality then any of the starting materials as such. Another technique used is to simply mill the surface covering of the panel, enabling up to about 85% of the panel material to be reused again.

### OBJECT OF THE INVENTION

It is an object of the invention to provide a new method for producing and recycling an object consisting of a panel durably provided with a surface covering, enabling a reuse of up to 100% of the panel and surface covering materials.

### SUMMARY OF THE INVENTION

In order to meet the object of the invention a method for producing and recycling an object consisting of a panel durably provided with a surface covering has been devised, the method comprising bringing the panel and the surface covering in a spatially aligned relationship, providing a layer of hot melt adhesive between the panel and the surface covering, heating the hot melt adhesive to a temperature above its melting temperature, pressing the surface covering against the panel with the molten hot melt adhesive in between the panel and surface covering, cooling down the hot melt adhesive to a temperature below its melting temperature to form the object, and after an end-of-life of the object, heating the hot melt adhesive to a temperature above its melting temperature, and separating the panel from the surface covering.

Applicant recognised that by applying a hot melt adhesive, i.e. an adhesive that above its melting temperature becomes liquid and loses its mechanical adherence properties, for durably bonding the surface covering to the panel, both materials can be separated relatively easy at the end-of-life of the panel by heating the hot melt adhesive to a temperature above its melting temperature. In the art this has not been proposed up to now since the separation by heating seems contradictory with a durable bonding. That is why in the art, if hot melt adhesives are suggested it is either for low end panels that do not need a durable bonding (such as panels for short-term use) or by using hot melt adhesives with very high melting temperatures (typically above 200° C.) which practically prevents the melting at its end-of-life.

For example, U.S. Pat. No. 4,089,721 shows the use of a hot melt adhesive for covering a panel with a decorative surface laminate for making furniture. Indeed, the method is not recognized as providing a product that can be re-used by separating the surface laminate from the panel by heating the product after its end of life. The most apparent reason for that is that the hot melt adhesive chosen has a very high melting temperature. Apparently, in order to safeguard that the bonding between the surface laminate and panel is stable even at elevated temperatures, the hot melt adhesive chosen has a very high melting temperature, namely above 175° C.-230° C. (350°-450° F.). This means that for re-melting the hot melt adhesive, the object as a whole needs to be heated to a temperature above at least 175° C.−230° C. This is not only very uneconomical, but also generates the risk of overheating the object, often mainly of wood and plastic, possibly setting it on fire (dry wood can self-inflame starting at about 200° C., processed wood such as structural board and some plastics even at temperatures as low as 175° C.). Also, the high temperature needed for separation makes it very difficult to remove the thin surface laminate (typically below 1 mm in thickness) from the panels, since the laminate, comprising a polymer layer, becomes less stable at these high temperatures. It was applicant's recognition however that for most applications, there is no need to use a hot melt adhesive having a melting point as high as 175-230° C. And even when such hot melt adhesives would be used, when applying panels and surface coverings that can withstand such high temperatures, separation of the panel and laminate after the end-of-life of the object is still feasible.

As another example of using hot melt adhesives, but not aiming at recycling through separation, U.S. Pat. No. 9,039,862 is mentioned. This recent patent relates to the use of a hot melt adhesive having a high hardness for the adhesive bonding of decorative films and foils. The reason for using a hot melt adhesive is explained to be the short curing time and the non-presence of solvents that may damage the panel. Recycling the end product by re-heating the object above a melting temperature of the hot melt adhesive followed by separating the substrate from its covering, is not mentioned. Indeed, using the hot melt adhesives as exemplified, this is not even possible without damaging the substrate and or foils. It is explained in U.S. Pat. No. 9,039,862 that the hot melt adhesive should be applied in the region of the softening point of the hot melt adhesive (typically between 120 and 150° C.), i.e. the temperature at which the adhesive becomes malleable but is not yet melted. This is to prevent damage of the materials (see column 13, lines 28-35). For actually melting, the adhesive should be heated to about 200° C. (see i.a. column 10, line 11). Indeed, at this temperature the materials would be damaged. This means that separating the materials by melting the hot melt adhesive is simply not possible with the exemplified hot melt adhesives in combination with the types of substrates and surface coverings.

Thus, the art does not obviate a method wherein an object is made by providing a durable bonding between a panel and surface covering, enabling at the same time the separation of the materials by re-heating the hot melt adhesive after the end-of-life of the object to a above a melting temperature of the hot melt adhesive. It was applicant's recognition that using a hot melt adhesive does enable a design of object that should be re-usable (i.e. able to be re-cycled) by separating the surface covering from the panel at its end-of-life.

It is noted that the method according to the invention is not restricted to carrying out the method steps in the order as described here above. For example, the layer of hot melt adhesive may be provided even before the panel and surface covering are brought in a spatially aligned relationship, for example by applying the hot melt adhesive on either of these materials when producing them. As another example, the pressing step may begin before the hot melt adhesive is heated to a temperature above its melting temperature. Also, two or more steps can be combined in one process step. For example, the first two steps, i.e. the aligning and providing hot melt steps, can be combined in one process step, like the pressing and heating step that can be combined in one process step. All these variations are covered by the scope of the claims.

The present invention also provided a new method of making an object by durably covering a panel with a surface covering, the method comprising providing a layer of hot melt adhesive on the panel, bringing the panel and the surface covering in a spatially aligned relationship, heating the hot melt adhesive to a temperature above its melting temperature, pressing the surface covering against the panel while the hot melt layer is an intermediate layer, and cooling down the hot melt adhesive to a temperature below its melting temperature to form the object. In the art (e.g. U.S. Pat. Nos. 4,089,721 and 9,039,862) the hot melt adhesive is applied to the surface covering, and thereafter, the heated surface covering is pressed to a panel to provide a durable bonding. Obviously, it is easier to heat the hot melt adhesive when present on a carrier with a small heat capacity and also, the provision of most surface coverings is a process that already implies stacking different layers of materials together. Therefore in the art the hot melt adhesive layer has consistently been applied to the surface covering. It was applicant who recognized that it is advantageous however to apply the hot melt adhesive to the panel. The surface covering is more vulnerable to mechanical impact and any additional process step increases the risk of damaging the surface of the covering (which surface usually is the aesthetic surface of an object to be made). Also, by applying the hot melt adhesive to the more robust panel, the use of surface coverings in other types of processes (for example using reactive or solvent adhesives) is not impaired due to the presence of a hot melt layer. This leaves all options open for the manufacturer of the end product, in particular by having the option, when desiring to design an object that is easy to recycle in accordance with the invention, to choose standard surface coverings and applying these standard surface coverings on panels previously provided with a layer of hot melt adhesive, or in the alternative, when design-for-reuse is not desired, to use these standard surface coverings in a traditional way by using traditional types of adhesives.

The present invention also provided a new panel, one surface of which is provided with a layer of hot melt adhesive having a melting temperature between 50 and 150° C., wherein the thickness of the layer is between 50 and 400 grams of hot melt adhesive per square meter.

### Definitions

A panel is a solid, self-supporting (dimensionally stable) substantially two dimensional object, i.e. a broad and thin, having length and width dimensions that are at least 10 times larger than its height dimension, preferably at least 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 200, 300, 400, 500 up to 1000 times or more longer or wider than its height (i.e. it's thickness in the direction of its smallest dimension), which object is typically but not necessarily rectangular, typically but not necessarily flat (the panel may be curved, corrugated, etc.), and usually forms or is set into the surface of a larger substrate such as a door, a wall, a ceiling, a piece of furniture, a tray etc. A panel intrinsically has stable dimensions but depending on its thickness a panel may be marginally flexed under stress. Typical examples of types of materials out of which panels are made for use in the construction of buildings, furniture and other household articles are OSB (oriented strand board), MDF (medium density fiberboard), PUR (polyurethane, mainly for insulation panels), PE (polyethylene, mainly for sandwich panels, or HDPE or any other type of high end PE), cellulosic fiber, wood, but may also be rubber, metal paper etc. A panel by itself may have a multilayer structure such as for example known from honeycomb panels. Typical weights for panels used in buildings, furniture and household items are between 2 and 20 kg/m², in particular between 3 and 10 kg/m² (as opposed to for example veneer or other surface laminates which have weights in the order of 0.4 to 0.8 kg/m²).

Durably means being able to resist wear during normal use. The term does not exclude that a durable object can be dismantled into its constituting parts.

A surface covering may be any object that can be used to cover a surface of a panel, such as veneer or other surface laminate, but it also may be another panel to form a multi-layer structure with the basic panel.

The end-of-life of an object refers to the actual point in time when a product ceases to exist in a particular state wherein it has the ability to perform its required function under normal use conditions. The end-of-life may be determined on the basis of various reasons such as aesthetic reasons, functional reasons, economic reasons etc.

A fibrous material is a material comprising fibers as (one of) its basic constituent(s). Examples of fibrous panels are boards pressed of wood fibers, wood particles, wood chips or of other plant materials.

A layer is a thickness of some material laid on or spread over a surface in a continuous manner, although a layer may have occasional spots or interruptions or may have a regular pattern of spots or interruptions (for example a reticulated layer).

Pressing an object means using force at least at the level of gravitational forces working on the object to push the object in a particular direction.

A hot melt adhesive is a thermoplastic adhesive that is designed to be melted, i.e. heated to above a melting temperature to transform from a solid state into a liquid state, (the melting temperature may be a melting range of a few degrees or more) and to adhere materials after solidification. Hot melt adhesives are non-reactive, (partly) crystalline and comprise less than 5, preferably less than 4, 3, 2, more preferably even less than 1 mass % or no amount of solvents so curing and drying are typically not necessary in order to provide adequate adhesion. In the liquid state the adhesive has a suitably low viscosity, is tacky and solidifies rapidly after cooling down to below its melting temperature (typically in a few seconds to one minute), with little or no drying needed. Unlike a pressure sensitive adhesive, a hot melt adhesive is not permanently tacky. Unlike solvent based adhesives, a hot melt adhesive does not shrink substantially or lose thickness as it solidifies.

The hot melt adhesives applied in the present invention are non-reactive. To the contrary the art teaches that adhesives for attaching and detaching articles should be reactive. It is not expected that non-reactive adhesives provide enough binding strength for high end applications, especially in view of the smooth surfaces typically present on panels and surface coverings. Also the absence of solvents was thought to be counter-beneficial to good adhesion. Solvents are known to help in wetting of the surface. When using hot melt adhesives comprising less than 5 mass % of solvents, it is expected that these crystallize quickly on a massive and/or cold substrate panel and thus wet the surface insufficiently for proper adhesion.

Useful hot melt adhesives suitable for use in the present invention may comprise a Polymer P present as a main constituent (i.e. in an amount of at least 50% by weight of the adhesive composition). Conveniently the hot melt adhesive comprises at least 60%, more conveniently at least 70%, most conveniently at least 80% of Polymer P by weight of the adhesive composition. Usefully the Polymer P and/or the hot-melt adhesive may be substantially bio-based (i.e. using naturally occurring materials). Polymer P is a thermoplastic polymer that is at least partly crystalline. Conveniently Polymer P is semi crystalline. Polymer P may have a melting point from 40 to 250° C. where the polymer is other than polyamide and where Polymer P comprises polyamide a melting point from 40 to 215° C. Usefully Polymer P has a melting point from 40 to 200° C., more usefully from 40 to 150° C. and most usefully from 70 to 120° C., for example about 110° C.

By “crystalline” is meant herein that polymer has a melting enthalpy (ΔHm) of at least 5 J/g, preferably at least 8 J/g, more preferably of at least 10 J/g, most preferably at least 15 J/g. A person skilled in the art would appreciate that many crystalline materials are not fully crystalline but have a degree of crystallinity which is less than 100%, preferably from 2 to 98%, more preferably from 5 to 90%, most preferably from 10 to 80%. Such materials comprise a mixture of phases such as domains of amorphous material and domains of crystalline material (e.g. where polymer chains are substantially aligned) and are often referred to by the informal term “semi-crystalline”. The different domains can be seen for example under a polarised light microscope and/or by transmission electron microscopy (TEM). The degree of crystallinity of a ‘semi-crystalline’ material may be measured by any suitable method such as by measuring density, by differential scanning calorimetry (DSC), by X-ray diffraction (XRD), by infrared spectroscopy and/or by nuclear magnetic resonance (NMR).

Polymer P may have a glass transition temperature below 100° C., advantageously below 80° C., more advantageously below 70° C., even more advantageously below 50° C. and most advantageously below 40° C.

Polymer P may have a melt viscosity (all measured at 150° C.) of less than 500 Pa·s, usefully less than 300 Pa·s, more usefully less than 200 Pa·s, most usefully less than 100 Pa·s. In one embodiment of the invention the Polymer P may have a melting point from 40 to 150° C., a glass transition temperature below 50° C. and a melt viscosity at 150° C. of less than 500 Pa·s. In another embodiment of the invention the Polymer P may have a melting point from 40 to 150° C., a glass transition temperature below 50° C. and a melt viscosity at 150° C. of less than 300 Pa·s. In yet another embodiment of the invention the Polymer P may have a melting point from 70 to 120° C., a glass transition temperature below 40° C. and a melt viscosity at 150° C. of less than 200 Pa·s.

In any of the embodiments the Polymer P is most preferably a (co)polyester. Polymer P may be a polymer obtained and/or obtainable by a polycondensation, a ring opening polymerisation of cyclic monomers and/or a step-growth polymerisation method. Polymer P may comprise one or more polymer or copolymer selected from the group consisting of: (co)polyurethane(s); (co)polycarbonate(s); (co)polyester(s), (co)polyamide(s); (co)poly(ester-amide(s); mixtures thereof and/or copolymers thereof. Although Polymer P can also comprise (co)polyurethane and/or a(co)polycarbonate type polymer(s) preferably Polymer P comprises (co)polyester(s), (co)polyamide(s) and/or poly(ester-amide)(s). More preferred Polymer P is obtained by a polycondensation and/or by a ring opening polymerisation of cyclic monomers (e.g. cyclic ester and/or cyclic amide). Even more preferred Polymer P comprises (co)polyester(s), most preferably polyester(s).

Preferably the weight average molecular weight (Mw) of the Polymer P is <500000 g/mol, more preferably <250000 g/mol and most preferably <100000 g/mol. Preferably the weight average molecular weight (Mw) of the Polymer P is >1000 g/mol more preferably >3500 g/mol and most preferably >5000 g/mol. Preferably the weight average molecular weight (Mw) of the Polymer P is from 100 to 500000 g/mol, more preferably from 3500 to 250000 g/mol and most preferably from 5000 to 100000 g/mol. Preferably the number average molecular weight (Mn) of the Polymer P is <300000 g/mol, more preferably <100000 g/mol and most preferably <50,000 g/mol. Preferably the number average molecular weight (Mn) of the Polymer P is >500 g/mol more preferably >1000 g/mol and most preferably >2000 g/mol. Preferably the number average molecular weight (Mn) of the Polymer P is from 100 to 300000 g/mol, more preferably from 500 to 100000 g/mol and most preferably from 2000 to 50000 g/mol. Usefully the weight average molecular weight (Mw) of the Polymer P (especially where they comprise polyester) is >3500 g/mol, more usefully >5000 g/mol, most usefully >8000 g/mol and especially >10000 g/mol. Usefully the weight average molecular weight (Mw) of the Polymer P (especially where they comprise polyester) is <75000 g/mol, more usefully <60000 g/mol, most usefully <50000 g/mol and especially <40000 g/mol. Usefully the weight average molecular weight (Mw) of the Polymer P (especially where they comprise polyester) is from 3500 to 75000 g/mol, more usefully from 5000 to 60000 g/mol, most usefully from 8000 to 50000 g/mol and especially from 10000 to 40000 g/mol, or even from 15000 to 30000 g/mol.

Usefully the number average molecular weight (Mn) of the Polymer P (especially where they comprise polyester) is >1500 g/mol, more usefully >2000 g/mol, most usefully >3000 g/mol and especially >5000 g/mol. Usefully the number average molecular weight (Mn) of the Polymer P (especially where they comprise polyester) is <60000 g/mol, more usefully <50000 g/mol, most usefully <40000 g/mol and especially <30000 g/mol. Usefully the number average molecular weight (Mn) of the Polymer P (especially where they comprise polyester) is from 1500 to 60000 g/mol, more usefully from 2000 to 50000 g/mol, most usefully from 3000 to 40000 g/mol and especially from 5000 to 30000 g/mol.

The molecular weight distribution (MWD) of the polymer may influence properties such as the equilibrium viscosity of the compositions comprising them. MWD is conventionally described by the polydispersity index (PDI). PDI is defined as the weight average molecular weight divided by the number average molecular weight (Mw/Mn) where lower values are equivalent to lower PDI's. Preferably the value of PDI is <30, more preferably <15, most preferably <10 and especially <5.

Although polyesters can be produced without the formation of a condensation, e.g. by polymerising epoxides with anhydrides, generic (co)polyester-amide may be formed by the condensation reaction of for example molecules having acid or anhydride functionalities with molecules having alcohol and/or amine functionalities. Thus for example polycondensation of suitable polyfunctional acids (preferably diacids) with suitable polyols (preferably diols or (mixtures with) tri- or tetrafunctional alcohols) or polycondensation of hydroxy acids can produce polyesters. Also ring opening polymerization of cyclic esters, such as caprolactone, pentadecalactone, ambrettolide and similar materials can produce polyesters. Similarly, polycondensation of suitable poly functional acids (preferably diacids) with suitable polyamines (preferably diamines or mixtures with trifunctional amines) or polycondensation of amino acids can produce polyamides. Ring opening polymerisation of cyclic amides, such as caprolactam, laurolactam and similar materials can produce polyamides. Analogously polycondensation of suitable poly functional acids (preferably diacids) with suitable polyamino alcohols (preferably dialkanol amine), polyols (preferably diols) and/or polyamines (preferably diamines) can produce poly(ester amides). Polyester amides can also be produced by (co)polymerization of lactones and/or lactams (as described herein). By having more than one of such functional groups on one molecule, polymers may be formed. If an amine such as dialkanol amine is used the resulting polyester resin is generally named as “polyester amide”. By having even more functional groups on one molecule it is possible to form hyperbranched polyesters as are well known in the art. By including polyisocyanate components urethanised polyesters (also known as polyester urethanes) may be formed.

Preferred amines and derivatives thereof that may be used to obtain a Polymer P comprise any alkyl-, alkanol-, alkoxyalkyl-, di- and polyamines, as well as amino acids, lactams and similar materials; ethylene diamine, butylene diamine, hexamethylene diamine, isophorone diamine, 2-Methylpentamethylenediamine, 1,3-pentanediamine, dimer fatty diamine (e.g. available from Croda under the trade mark Priamine®), ethanolamine, diethanol amine, isopropanol amine, diisopropanol amine, caprolactam, laurolactam, lysine, glycine and/or glutamine. Thus, it is well known that polyesters, which contain carbonyloxy (i.e. —C(═O)—O—) linking groups may be prepared by a condensation polymerisation process in which monomers providing an “acid component” (including ester-forming derivatives thereof) are reacted with monomers providing a “hydroxyl component”.

The monomers providing an acid component may be selected from one or more polybasic carboxylic acids such as di- or tri-carboxylic acids or ester-forming derivatives thereof such as acid halides, anhydrides or esters. The monomers providing a hydroxyl component may be one or more polyhydric alcohols or phenols (polyols) such as diols, triols, etc. It is to be understood, that the polyester resins described herein may optionally comprise autoxidisable units in the main chain or in side chains' and such polyesters are known as autoxidisable polyesters. If desired the polyesters may also comprises a proportion of carbonylamino linking groups —C(═O)—NH— (i.e. amide linking group) or —C(═O)—N—R²— (tertiary amide linking group) by including an appropriate amino functional reactant as part of the hydroxyl component or alternatively all of the hydroxyl component may comprise amino functional reactants, thus resulting in a polyester amide resin. Such amide linkages are in fact useful in that they are more hydrolysis resistant.

There are many examples of carboxylic acids (or their ester forming derivatives such as anhydrides, acid chlorides, or lower (i.e. C₁₋₆)alkyl esters) which can be used in polyester synthesis for the provision of the monomers providing an acid component. Examples include, but are not limited to monofunctional acids such as (alkylated) benzoic acid and hexanoic acid; and C₄₋₂₀ aliphatic, alicyclic and aromatic dicarboxylic acids (or higher functionality acids) or their ester-forming derivatives. Preferred examples of suitable acids and derivatives thereof that may be used to obtain a polyester comprise any of the following: adipic acid, fumaric acid, maleic acid, citric acid, succinic acid, itaconic acid, azelaic acid, sebacic acid, suberic acid, pimelic acid nonanedioic acid, decanedioic acid, 1,4-cyclohexanedicarboxylic acid, 1,3-cyclohexanedicarboxylic acid, 1,2-cyclohexanedicarboxylic acid, terephthalic acid, isophthalic acid, sulfoisophthallic acids and/or metal salts thereof (e.g. 5-sodiosulpho isophthalic acid), phthalic acid, tetrahydrophthalic acid, 2,5-furanedicarboxylic acid (FDCA), any suitable mixtures thereof, combinations thereof and/or any suitable derivatives thereof (such as esters, e.g. di(C₁₋₄alkyl) esters, metal salts and/or anhydrides). Suitable anhydrides include succinic, maleic, phthalic, trimellitic and hexahydrophthalic anhydrides. More preferred (co)polyesters may be obtained from the following acids: terephthalic acid, isophthalic acid, succinic acid, suberic acid, pimelic acid, adipic acid, fumaric acid, maleic acid, itaconic acid, dimer fatty acid, sebacic acid, azelaic acid, sulfoisophthallic acid (and/or its metal salt), 1,3-cyclohexanedicarboxylic acid, 1,4-cyclohexane dicarboxylic acid, 2,5-furane dicarboxylic acid, trimellitic anhydride, esters thereof (e.g. dialkyl esters thereof), combinations thereof and/or mixtures thereof.

Similarly there are many examples of polyols which may be used in (optionally autoxidisable) polyester resin synthesis for the provision of the monomers providing a hydroxyl component. The polyols preferably have from 1 to 6 (more preferably 2 to 4) hydroxyl groups per molecule. Suitable monofunctional alcohols include for example eicosanol and lauryl alcohol. Suitable polyols with two hydroxy groups per molecule include diols such as 1,2-ethanediol, 1,3-propanediol, 1,4-butanediol, 2,3-butanediol, 1,6-hexanediol, 2,2-dimethyl-1,3-propanediol (neopentyl glycol), the 1,2-, 1,3- and 1,4-cyclohexanediols and the corresponding cyclohexane dimethanols, diethylene glycol, dipropylene glycol, and diols such as alkoxylated bisphenol A products, e.g. ethoxylated or propoxylated bisphenol A. Suitable polyols with three hydroxy groups per molecule include triols such as trimethylol propane (TMP) and 1,1,1-tris (hydroxymethyl)ethane (TME). Suitable polyols with four or more hydroxy groups per molecule include bis-TMP, pentaerythritol (2,2-bis(hydroxymethyl)-1,3-propanediol), bis-pentaerythritol and sorbitol (1,2,3,4,5,6-hexahydroxyhexane). Examples of hydroxyl functional amines with both hydroxyl functionality and amine functionality are described in, for example, WO 00/32708, use of diisopropanol amine is preferred. These can be used to prepare polyester amide resins.

Elastomeric polyols may also be used as building blocks to prepare the Polymer P (e.g. a polyester) and suitable polyols may comprise dihydroxy-terminated polytetrahydrofuran (polyTHF), dihydroxy-terminated polypropylene glycol, dihydroxy-terminated polybutylene succinate, dihydroxy-terminated polybutylene adipate; other aliphatic polyesters with Tg below zero and two OH end groups; and/or any mixtures thereof and/or any combinations thereof. Examples of suitable copolyester elastomers that may be obtainable and/or obtained from such polyols are those available from DSM under the trade mark Arnitel®.

Preferred examples of suitable alcohols that may be used to obtain a polyester Polymer P comprise any of the following; isosorbide, ethylene glycol, 1,2-propanediol, 1,3-propandiol, 1,5-pentanediol, neopentyl glycol, diethylene glycol, triethylene glycol, 1,8-octanediol, 2,2,4-trimethyl-1,3pentanediol, polyethylene glycol, polypropylene glycol, 2,2,4,4-tetramethyl-1,3-cyclobutanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 1,3-butanediol, 2,3-butanediol (e.g. from a renewable source) 1,5-pentanediol, 1,6-hexandediol, 1,4-butanediol, dimer fatty acid diol, glycerol, pentaerythrithol, di-pentaerythritol, any suitable combinations and/or mixtures thereof.

In yet another embodiment the (co) polyester may be built up from an acid selected from terephthalic acid, isophthalic acid, succinic acid, suberic acid, pimelic acid, adipic acid, fumaric acid, maleic acid, itaconic acid, dimer fatty acid, sebacic acid, azelaic acid, sulfoisophthallic acid or its metal salt, 1,3-cyclohexanedicarboxylic acid, 1,4-cyclohexane dicarboxylic acid, furane dicarboxylic acid, trimellitic anhydride and/or dialkyl esters thereof, mixtures thereof together with an alcohol selected from: ethylene glycol, 1,2-propanediol, 1,3-propandiol, 1,5-pentanediol, neopentyl glycol, diethylene glycol, triethylene glycol, 1,8-octanediol, 2,2,4-trimethyl-1,3-pentanediol, polyethylene glycol, polypropylene glycol, 2,2,4,4-tetramethyl-1,3-cyclobutanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 1,3-Butanediol, 2,3-butanediol, 1,5-pentanediol, 1,6-Hexandediol, 1,4-butanediol, dimer fatty acid diol, glycerol, pentaerythrithol, di-pentaerythritol and/or mixtures thereof. Dimer fatty acids, dimer fatty diols and/or dimer fatty diamines (e.g. available from Croda) may also be used as potential building blocks to obtain Polymer P.

The esterification polymerisation processes for making the polyester for use in the invention composition are well known in the art and need not be described here in detail. Suffice to say that they are normally carried out in the melt optionally using catalysts such as titanium- or tin-based catalysts and with the provision for removing any water (or alcohol) formed from the condensation reaction. Preferably if the polyester resin comprises carboxylic acid functionalities, they are derived from a polyacid and or anhydride.

The (co)polyester and other resins described herein as suitable for Polymer P may also comprise acidic moiet(ies) other than carboxylic acid moieties for example where the resin is prepared from a strong acid such as sulfonated acids, phosphonated acids, derivatives thereof (e.g. esters) and/or salts thereof (e.g. alkali metal salts). Preferred non-carboxylic acid moiet(ies) comprises neutralized or partially neutralized strong acid group selected from sulfonated moieties, phosphonated moieties and/or derivatives thereof, more preferably is an aromatic sulfonated acid or salt thereof, most preferably is an alkali metal sulfo salt of a benzene dicarboxylic acid, for example is represented by formula:

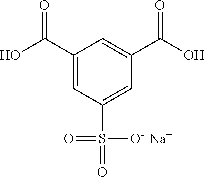 [SMILES: O=C(O)c1cc(C(=O)O)cc(S(=O)(=O)[O-])c1 ; [Na+]]

### Sodium salt of 5-(sulfo)isophthalic acid (SSIPA)

Preferably the weight average molecular weight (Mw) of the polyester amide resin or urethanised polyester(-amide) resin is <20,000 g/mol, more preferably <12,000 g/mol and most preferably <9,000 g/mol. Preferably the polyester amide resin or autoxidisable urethanised polyester(-amide) resin has a PDI less than 8, more preferably a PDI less than 5.5, most preferably a PDI less than 4.0. Preferably the polyester amide resin or urethanised polyester(-amide) resin has a carbonyl amine content (defined as the presence of NH—C═O or N—C═O in mmoles/100 g solid resin) of at least 10 mmoles/100 g solid resin, more preferably at least 20 mmoles/100 g, most preferably at least 50 mmoles/100 g solid resin and especially at least 65 mmoles/100 g solid resin.

In addition the polyester amide resin or urethanised polyester(-amide) resin preferably has a carbonyl amine content (defined as the presence of NH—C═O or N—C═O in mmoles/100 g solid resin) of less than 500 mmoles/100 g solid resin, more preferably less than 400 mmoles/100 g solid resin, most preferably less than 300 mmoles/100 g solid resin and especially less than 225 mmoles/100 g solid resin.

In one embodiment Polymer P comprises a (co)polyester, characterised in that the (co)polyester is obtained and/or obtainable from reacting at least one acid selected from terephthalic acid, 2,5-furanedicarboxylic acid, adipic acid, fumaric acid, dimer fatty acid, sebacic acid, azelaic acid, succinic acid, and/or combinations thereof with at least one alcohol selected from ethylene glycol, 1,6-hexanediol, 1,4-butanediol, dimer fatty acid diol and/or combinations thereof. Usefully the hot melt adhesive used in the present invention comprises (in addition to the Polymer P) up to maximally 50% by weight of optional ingredients selected from, tackifiers, waxes, plasticizers, nucleating agents, anti-static agents, neutralising agents, adhesion promoters, pigments, dyes, emulsifiers, surfactants, thickeners, heat stabilisers, levelling agents, anti-cratering agents, fillers, sedimentation inhibitors, UV absorbers, antioxidants, dispersants, defoamers, co-solvents, wetting agents, reactive diluents and the like and/or combinations thereof introduced at any stage of the production process or subsequently. Preferably, the hot melt adhesive used in the present invention does not comprise metal fillers. If present any reactive diluents have an Mn >1000 g/mol, more preferably >1500 g/mol and most preferably >2000 g/mol and preferably an Mn<5000 g/mol, more preferably <4000 g/mol and especially <3500 g/mol. It is also possible to include fire retardants like antimony oxide in the adhesive to enhance the fire retardant properties of the adhesive.

Some non-limiting examples of tackifiers include tall oil, gum or wood rosin either unmodified, partially hydrogenated, fully hydrogenated or disproportionated, polymerized rosins, rosin derivatives such as rosin esters, phenolic modified rosin esters, acid modified rosin esters, distilled rosin, dimerised rosin, maleated rosin, and polymerized rosin; hydrocarbon resins including aliphatic and aromatic resins, coumarone-indene resins, polyterpenes, terpene-phenolic resins, maleic resins, ketone resins, reactive resins, hybrid resins and polyester resins.

Plasticisers can be used to reduce the glass transition temperature (Tg) of the polymer. Some non-limiting examples of a plasticizer include benzoate esters, phthalate esters, citrate esters, phosphate esters, terephthalate esters, isophthalate esters, or combinations thereof. As is well known to a skilled person other suitable commercially available plasticisers can also be used to prepare hot melt adhesives for use in the present invention.

The adhesive also can comprise one or more compatible waxes to improve the bond strength, prevent or reduce cold flow, and to decrease set time. Some non-limiting examples are 12-hydroxystearamide, N-(2-hydroxy ethyl)-12-hydroxystearamide, stearamide, glycerine monostearate, sorbitan monostearate, 12-hydroxy stearic acid, N,N′-ethylene-bis-stearamide, hydrogenated castor oil, oxidized synthetic waxes, and functionalized synthetic waxes such as oxidized polyethylene waxes.

Nucleating agents may be used with the adhesive composition to modify and control crystal formation. The terms “nucleating agent” and “nucleator” are synonymous and refer to a chemical substance which when incorporated into polymers form nuclei for the growth of crystals in the polymer melt. Any incompatible material can serve as a nucleator provided that it rapidly separates into particles as the molten adhesive cools. There are a wide variety of organic and inorganic materials known as nucleating agents that skilled person would be able to select as suitable for use in the present invention. Low molecular weight polyolefins and/or olefinic ionomers with a melt temperature from 70° C. to 130° C. or talcum are non-limiting examples of suitable nucleating agents that could be used in the present invention.

Preferred hot melt adhesives that are suitable for use in the present invention exhibit one or more (more preferably all) of the following properties: They can be applied (in a molten state) at a temperature from 40 to 150° C., preferably from 70 to 130° C.; they have a viscosity of less than 500 Pa·s, preferably <250 Pa·s at 150° C.; they have a melt temperature (also denoted Tₘ) of from 40 to 150° C.; and a crystallisation temperature (also denoted T_{c}) of from 60 to 130° C. In particular preferred are such hot melt adhesives when exhibiting a melt viscosity typically even below 150 Pa·s. Hot melt adhesives that are particularly suitable for use in the present invention is a polyester adhesive having a crystallinity between 5% and 40% and a viscosity of 5-55 Pa·s at 150° C. Regarding the crystallinity, this can have any value between 5 and 40% such as 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38 and 39%. Typical ranges are 5-30 and 10-30%. Regarding the melt viscosity, this may have any value between 5 and 55 Pa·s such as 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53 and 54 Pa·s. Tₘ and T_{c} may be obtained by any suitable method such as Differential Scanning calorimetry (DSC). If melting and/or crystallisation of a sample is observed over a temperature range, the Tₘ and/or T_{c} values are recorded as the peak (maximum) temperature observed in this range. The viscosity of a polymer adhesive can be measured by using a cone and plate viscometer (Brookfield CAP 2000+, available from Brookfield Ametek, Middleboro, Mass., USA) with a 24 mm diameter spindle and a cone angle of 1.8 degrees (Brookfield Cap 2000 +spindle #4). Samples are heated to 150° C. At 150° C. the spindle is lowered on the sample. The sample is measured at 21 rpm for 30 seconds. The viscosity is determined automatically by the viscometer's default algorithm.

### EMBODIMENTS

In an embodiment of the method according to the invention, the hot melt adhesive has a melting temperature between 40 and 150° C. In particular this temperature is 41, 45, 50, 55, 60, 65, 70, 75, 80, 85, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 135, 140, 145 up to 149° C. or any temperature in between two consecutive temperatures as explicitly mentioned. The relatively low temperature, against the consistent teachings of the prior art to use melting temperatures typically above 175° C. or even above 200° C., was found to be suitable to form a durable bond between a panel and a surface covering. The great advantage is that the crystallisation temperature of the hot melt adhesive is also inherently lower. This makes it much easier to actually adhere the surface covering in the right way, in the right position on the panel. Namely, the lower the crystallisation temperature is, the easier it is to keep the temperature slightly above this crystallisation temperature, which is needed during the positioning of the surface covering since below the crystallisation temperature here is an instant durable bonding, not allowing any re-positioning anymore. Also, the lower the crystallisation temperature, the more time there is under normal environmental conditions before the adhesive is cooled down to its solid state.

In another embodiment the layer of hot melt adhesive has a thickness of between 50 and 400 g/m². In particular the thickness is 51, 55, 60, 65, 70, 75, 80, 85, 90, 85, 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 310, 320, 330, 334, 350, 360, 370, 380, 390, 399 g/m² or any thickness in between two consecutive temperatures as explicitly mentioned. At a thickness below 50 g/m² the bonding of the surface covering to the panel may not be strong enough, depending on the type of panel, to provide for a durable bonding, mainly due to the presence of areas without the required amount of adhesive to fill up unevenness in the surface. At a thickness above 400 g/m² the bonding may also be not strong enough, mainly depending on the particular materials used and the type and level of forces exerted on the object, due to the brittle nature of a thick layer of solid hot melt adhesive.

In one embodiment the layer of hot melt adhesive is provided as such that the layer corresponds substantially to the complete region of overlap between the panel and the surface covering. As such a full-surface bonding is obtained.

In yet another embodiment the layer of hot melt adhesive is heated by using radiation. It was found that by using radiation, such as microwaves, infrared light or other types of radiation, a very advantageous method of providing sufficient heat to the adhesive can be obtained. The advantage namely is that the substrates themselves (i.e. the panel and surface covering) do not need to be heated, at least not to the same overall temperature as the hot melt adhesive. This not only leads to an increased energy efficiency, but provides more freedom to use particular materials for the panel and surface covering which could not be used if one or more of these items also needed to be heated to above a temperature at which the hot melt adhesive melts. A potential downside of immediate cooling down of the hot melt adhesive when coming in contact with the colder panel and/or surface covering, can also be turned into an advantage, namely increased process speed.

In still another embodiment the layer of hot melt adhesive is provided by connecting this layer to a surface of the panel before the panel and surface covering are brought in the spatially aligned relationship. In the art (e.g. U.S. Pat. Nos. 4,089,721 and 9,039,862) the hot melt adhesive is applied (and therewith connected) to the surface covering, and thereafter, the heated surface covering is pressed to a panel to provide a durable bonding. Apparently, it has always been found easier to heat the hot melt adhesive when present on a carrier with a small heat capacity and also, the provision of most surface coverings is a process that already implies stacking different layers of materials together. Therefore in the art the hot melt adhesive layer has consistently been applied to the surface covering. It was applicant who recognized that it is advantageous however to apply the hot melt adhesive to the panel. The surface covering is more vulnerable to mechanical impact and any additional process step increases the risk of damaging the surface of the covering (which surface usually is the aesthetic surface of an object to be made). Also, by applying the hot melt adhesive to the more robust panel, the use of surface coverings in other types of processes (for example using reactive or solvent adhesives) is not impaired due to the presence of a hot melt layer. This leaves all options open for the manufacturer of the end product, in particular by having the option, when desiring to design an object that is easy to recycle in accordance with the invention, to choose standard surface coverings and applying these standard surface coverings on panels previously provided with a layer of hot melt adhesive, or in the alternative, when design-for-reuse is not desired, to use these standard surface coverings in a traditional way by using traditional types of adhesives.

In a further embodiment, the layer of hot melt adhesive is applied to the surface of the panel using a roller provided with a mass of molten hot melt adhesive. Although panels are not able to adapt their form to the circumference of a roller, and also, although hot melt guns, and other devices have been found suitable for applying a layer of hot melt adhesive to a (rigid) panel, it has been found that a roller, can be advantageously used to apply a hot melt adhesive for use in the present invention.

In yet a further embodiment, the layer of hot melt adhesive is cooled down to a temperature below the melting temperature of the hot melt adhesive before the panel and surface covering are brought in the spatially aligned relationship. It has been found that it is advantageous before the actual bonding step takes place to cool the hot melt adhesive to form a solid, non-tacky layer. This provides the option for a quality check of the layer before actual bonding takes place and also, to have a more flexible producing process wherein firstly a set of multiple panels provided with a layer of hot melt adhesive are produced, and only after some time this set of panels is covered in a separate process with the surface covering. Hot melt adhesive remains stable when cooled down and due to its non-tacky nature, there is no substantial risk of deterioration of the layer by absorbing exogenous material. For example, the layer of hot melt adhesive is provided at a location remote from a production location of the object (i.e. situated at some distance away from the production location of the object, as opposed to at the same site, i.e. the exact location, of the actual production, e.g. in another production hall, at another production site, or in another country etc), wherein the panel provided with the layer of hot melt adhesive is transported to the production location.

It is not only an important advantage of the present invention that the panel can be pre-produced with a layer of hot melt adhesive at a production site remote from the site where the ultimate object is produced. It was also found that it is advantageous that a protective foil is not needed to protect the layer of adhesive during transport or storage. The hot melt adhesive at room temperature is a very stable layer, non-tacky, and can be preserved for years under normal circumstances. Therefore, in again a further embodiment multiple panels provided with a layer of hot melt adhesive are transported and/or stored while being in a stacked arrangement without a protective foil being present on each layer of hot melt adhesive.

If needed, the method comprises a step of removing exogenous particles from the surface of the layer of hot melt adhesive before the hot melt adhesive is heated to a temperature above its melting temperature. During transport, storage or even during an initial adhering effort, it might be that dust or other exogenous particles are collected on the surface of the layer of hot melt adhesive. Since these particles might negatively influence the bonding process, it is advantageous to remove these particles before the hot melt adhesive is heated to serve as an actual adhesive between the panel and the surface covering. Would a particle be included inadvertently during an initial adhering effort, the hot melt adhesive could be reheated again to separate the panel from its covering, where after the particle is removed to enable a high quality formation of the object.

If the cooling down of the hot melt adhesive after it has been melted needs to be at a lower speed, in an embodiment it is foreseen that the panel and/or surface covering are heated before the panel and surface covering are pressed together.

In an embodiment of the method according to the invention the panel is a fibrous material. It was found that the present invention can be advantageously used in a method wherein the panel is a fibrous material. It was found that extremely high bonding strengths can be obtained even when using a hot melt adhesive having a melting temperature of around 120° C., thus having a relatively low molecular weight and low intrinsic molecular-molecular binding. The high bond strength is not understood completely but may be partly due to the slightly porous nature of a fibrous material leading to a good entanglement of the polymer molecules in the panel.

In a further embodiment the fibrous material comprises cellulosic fibres. In particular made from fibrous pulp of plant material such as wood, or any material from plants of the family of poaceae or gramineae, a large and nearly ubiquitous family of monocotyledonous flowering plants known as grasses. Poaceae includes the cereal grasses, bamboos, cane, reeds and the grasses of natural grassland. Typical examples of materials used are wood chips and particles, fibres of cane, reed, flex and hemp, and fibres of grains such as brewers grains. In yet a further embodiment the fibrous material comprises artificial polymer (i.e. a man-made polymer) in addition to the cellulosic fibres. Panels made of a combination of cellulosic fibres and artificial polymer material have recently been introduced to the market by ECOR (San Diego, USA) as an alternative to particle board, and can be made for example from recycled coffee cups or recycled milk cartons. These panels are ideally suitable to be used in the present invention.

Still, in another embodiment the hot melt adhesive comprises a polyester polymer. A polyester polymer has found to be useful for application in the present invention. In particular useful is a condensation polymer. The polymer may have a weight averaged molecular weight (Mw) between 15,000 and 30,000 g/mol. In particular, the weight averaged molecular weight advantageously has a value of 15001, 15500, 16000, 16500, 17000, 17500, 18000, 18500, 19000, 19500, 20000, 20500, 21000, 21500, 22000, 22500, 23000, 23500, 24000, 24500, 25000, 2550, 26000, 26500, 27000, 27500, 28000, 28500, 29000, 29500 up to 29999 g/mol or any other value in between two consecutive values of these. In particular, the polymer may have a crystallinity of between 5 and 40%. Regarding the crystallinity, this can have any value between 5 and 40% such as 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38 and 39%. Typical ranges are 5-30 and 10-30%.

Again, in another embodiment, for separating the surface covering from the panel, the hot melt adhesive is heated to a temperature above its melting temperature using radiation. It was found that by using radiation, such as microwaves, infrared light or other types of radiation, a very advantageous method of providing sufficient heat to the adhesive in order to re-melt it for separating the constituting panel and surface covering, can be obtained. The advantage namely is that the substrates themselves (i.e. the panel and surface covering) do not need to be heated, at least not to the same overall temperature as the hot melt adhesive. This not only leads to an increased energy efficiency, but provides more freedom to use particular materials for the panel and surface covering which could not be used if one or more of these items also needed to be heated to above a temperature at which the hot melt adhesive melts. For example, materials that deform when subjected to temperatures typical for melting a hot melt adhesive cannot be used when the complete object is heated. However, in this embodiment such materials may be usable, depending of course on the amount of heat absorbed by these materials when the intermediate hot melt layer is melted.

The method for producing an object consisting of a panel durably provided with a surface covering, as outlined here above, in a further embodiment uses a panel having a surface larger than 0.3 m². In particular, the panel has a surface larger than 0.4, 0.5, 0.6, 0.7, 0.8, 0.9, 1, 1.5, 2, 2.5 or even larger than 3 m².

In another embodiment of this further method in line with the invention, the hot melt adhesive has a melting temperature between 40 and 150° C. In particular this temperature is 41, 45, 50, 55, 60, 65, 70, 75, 80, 85, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 135, 140, 145 up to 149° C. or any temperature in between two consecutive temperatures as explicitly mentioned. The relatively low temperature, against the consistent teachings of the prior art to use melting temperatures typically above 175° C. or even above 200° C., was found to be suitable to form a durable bond between a panel and a surface covering as explained here above.

In another embodiment the layer of hot melt adhesive has a thickness of between 50 and 400 g/m². In particular the thickness is 51, 55, 60, 65, 70, 75, 80, 85, 90, 85, 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 310, 320, 330, 334, 350, 360, 370, 380, 390, 399 g/m² or any thickness in between two consecutive temperatures as explicitly mentioned. As explained here above, at a thickness below 50 g/m² the bonding of the surface covering to the panel may not be strong enough, depending on the type of panel, to provide for a durable bonding, mainly due to the presence of areas without the required amount of adhesive to fill up unevenness in the surface. At a thickness above 400 g/m² the bonding may also be not strong enough, mainly depending on the particular materials used and the type and level of forces exerted on the object, due to the brittle nature of a thick layer of solid hot melt adhesive.

In an embodiment the panel is a fibrous material. It was found, as explained here above, that the present invention can be advantageously used in a method wherein the panel is a fibrous material. It was found that extremely high bonding strengths can be obtained even when using a hot melt adhesive having a melting temperature of around 120° C., thus having a relatively low molecular weight and low intrinsic molecular-molecular binding.

In a further embodiment the fibrous material comprises cellulosic fibres, in particular made from fibrous pulp of plant material such as wood, or any material from plants of the family of poaceae or gramineae, a large and nearly ubiquitous family of monocotyledonous flowering plants known as grasses. As stated hereinbefore, panels made of a combination of cellulosic fibres and polymer material have recently been introduced to the market by ECOR (San Diego, USA) as an alternative to particle board, and can be made for example from recycled coffee cups or recycled milk cartons. These panels are ideally suitable to be used in the present invention.

Still, in another embodiment the hot melt adhesive comprises a condensation polymer. A condensation polymer has found to be useful for application in the present invention. In particular useful is a polyester polymer, for example a polymer having a weight averaged molecular weight (Mw) between 15,000 and 30,000 g/mol. In particular, the weight averaged molecular weight can have a value of 15001, 15500, 16000, 16500, 17000, 17500, 18000, 18500, 19000, 19500, 20000, 20500, 21000, 21500, 22000, 22500, 23000, 23500, 24000, 24500, 25000, 2550, 26000, 26500, 27000, 27500, 28000, 28500, 29000, 29500 up to 29999 g/mol or any other value in between two consecutive values of these. In particular, the polymer may have a crystallinity of between 5 and 40%. Regarding the crystallinity, this can have any value between 5 and 40% such as 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38 and 39%. Typical ranges are 5-30 and 10-30%.

The panel according to the invention, having one surface of which is provided with a layer of hot melt adhesive having a melting temperature between 40 and 150° C. and a thickness of the layer is 50-400 g/m², is embodied in that the panel has a surface greater than 0.5 m².

In an embodiment the panel is a fibrous material. It was found, as explained here above, that the present invention can be advantageously used in a method wherein the panel is a fibrous material. It was found that extremely high bonding strengths can be obtained even when using a hot melt adhesive having a melting temperature of around 120° C., thus having a relatively low molecular weight and low intrinsic molecular-molecular binding.

In a further embodiment the fibrous material comprises cellulosic fibres, in particular made from fibrous pulp of plant material such as wood, or any material from plants of the family of poaceae or gramineae, a large and nearly ubiquitous family of monocotyledonous flowering plants known as grasses. As stated hereinbefore, panels made of a combination of cellulosic fibres and polymer material have recently been introduced to the market by ECOR (San Diego, USA) as an alternative to particle board, and can be made for example from recycled coffee cups or recycled milk cartons. These panels are ideally suitable to be used in the present invention.

Still, in another embodiment the hot melt adhesive comprises a condensation polymer. A condensation polymer has found to be useful for application in the present invention. In particular useful is a polyester polymer, for example a polymer having a weight averaged molecular weight (Mw) between 15,000 and 30,000 g/mol. In particular, the weight averaged molecular weight can have a value of 15001, 15500, 16000, 16500, 17000, 17500, 18000, 18500, 19000, 19500, 20000, 20500, 21000, 21500, 22000, 22500, 23000, 23500, 24000, 24500, 25000, 2550, 26000, 26500, 27000, 27500, 28000, 28500, 29000, 29500 up to 29999 g/mol or any other value in between two consecutive values of these. In particular, the polymer may have a crystallinity of between 5 and 40%. Regarding the crystallinity, this can have any value between 5 and 40% such as 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38 and 39%. Typical ranges are 5-30 and 10-30%.

The invention will now be explained on the basis of the following particular but non-limiting examples.

### EXAMPLES

### Example 1

An MDF panel of 21×15×2 cm (length×width×thickness) was covered at room temperature with powdered polyester hot melt adhesive (obtainable as LA 1030 from DSM, Heerlen, The Netherlands) having a melting temperature of approximately 120° C. The panel was put in the oven with a second MDF panel on top of the first panel as a surface covering with the hot melt adhesive in between the panels. The heat melted the adhesive to form a layer between the two panels, one of which covered the surface of the other in terms of the present invention. No extra force but gravity was applied to press the top panel in the direction of the bottom panel. After melting of the adhesive, the panels were taken out of the oven and allowed to cool down again to room temperature, effectively therewith forming an object in the sense of the present invention. The panels appeared to be durably bonded to each other. When warming the object to 150° C., the panels are easily separated using mere forces by hand.

### Example 2

The same adhesive as used in example 1 was applied onto one half (150 mm) of a strip having dimensions of 300×15×2.5 mm (l×w×t), cut out of a larger panel of Ecor Raw (a panel based on recycled kraft paper and wood fibers, obtainable from Ecor, San Diego USA), by pouring it as a liquid out of an oven-heated (170° C.) 100 ml jar (allowing the formation of a very thin layer due to the very low viscosity at this high temperature) and letting it cool down to room temperature. A second cold Ecor strip was put on top of the first strip (completely overlaying this first strip) with the adhesive in between (50% of the surface), and the combination was put in the oven at 180° C. with 6 kg of weight on top of the laminate. After 15 minutes, the weight was removed and the laminate was taken out of the oven and left to cool down to room temperature to lead to the two-layer object. The adhesion of the two panel strips at room temperature was such that when the strips were pulled apart in opposing directions at the non-adhered end, the Ecor strips (and not the adhesive layer) failed. When warming the object to 150° C., the panels are easily separated using mere forces by hand.

### Example 3

An Ecor Raw strip as used in example 2 was coated with the same hot melt adhesive using a Reka TR 60 LCD glue gun with swirl head (Reka Klebetechnik, Eggenstein, Germany) and allowed to cool down to room temperature. A hot air blower was used to melt the adhesive again, whereafter a leather surface covering was applied onto the molten adhesive with the suede side of the leather directed to the adhesive, leaving one end of the leather non-adhered to the panel. After cooling, the adhesion was such that when pulling the free end of the leather, hairs of the suede side were pulled out of the leather, indicating a very durable bonding between the leather surface covering and the Ecor panel. When warming the object to 150° C., the leather is easily removed using mere forces by hand.

### Example 4

A lightboard Ecor panel (obtainable under the tradename HoneyCOR™) was coated with the same hot melt adhesive using a Lacom MPBL 600 pilot So laminator machine (Lacom GmbH, Lauchheim, Germany) having a roller to apply molten hot melt adhesive. The result after cooling was a smooth layer of solid adhesive on the lightboard Ecor panel, ready for application of a surface covering.

### Example 5

The surface of an MDF panel of 10×15×2 cm was coated with the same hot melt adhesive using the Reka TR 60 LCD glue gun. The adhesive was distributed evenly over the MDF panel using a large palette knife. The adhesive was cooled down to room temperature. After cooling veneer (Decoflex oak dosse having a thickness of 0.6 mm, Decospan, Menen, Belgium) was placed on top of the panel, heated and pressed using a flat iron (at a standard iron temperature of ±180° C., using hand pressure) to melt the adhesive. After cooling the veneer adhered to the MDF panel with very good adhesion, proving a durable connection between the panel and the veneer.

### Example 6

An MDF panel of 33×45×2 cm with one sloping side (±45°; taking about 2 cm to go from full thickness to nil) was coated with the hot melt adhesive using the Reka TR 60 LCD glue gun. The adhesive was distributed evenly over the MDF panel and sloping side using a large palette knife. The adhesive was cooled down to room temperature. After cooling veneer (Decoflex oak dosse, see example 5) was placed on top of the panel and heated and pressed using flat iron (standard iron temperature of ±180° C., using hand pressure). The veneer was also glued to the sloping side and over the tip of this side (i.e. to the back of the MDF panel). The adhesion of the veneer onto the MDF was very good, especially on the sloping side and back side, proving a durable connection between the panel and the veneer.

1. A method for producing and recycling an object consisting of a panel durably provided with a surface covering, comprising:
bringing the panel and the surface covering in a spatially aligned relationship,
providing a layer of hot melt adhesive between the panel and the surface covering, wherein the hot melt adhesive is non reactive and comprises less than 5 mass % of solvents,
heating the hot melt adhesive to a temperature above its melting temperature,
pressing the surface covering against the panel with the molten hot melt adhesive in between the panel and surface covering,
cooling down the hot melt adhesive to a temperature below its melting temperature to form the object, and
after an end-of-life of the object, heating the hot melt adhesive to a temperature above its melting temperature, and
separating the panel from the surface covering.

2. A method according to claim 1, wherein the hot melt adhesive has a melting temperature between 40 and 150° C.

3. A method according to claim 1, wherein the layer of hot melt adhesive has a thickness of between 50 and 400 g/m².

4. A method according to claim 1, wherein the layer of hot melt adhesive is heated by using radiation.

5. A method according to claim 1, wherein the layer of hot melt adhesive is provided by connecting this layer to a surface of the panel before the panel and surface covering are brought in the spatially aligned relationship.

6. A method according to claim 5, wherein the layer of hot melt adhesive is applied to the surface of the panel using a roller provided with a mass of molten hot melt adhesive.

7. A method according to claim 5, wherein the layer of hot melt adhesive is cooled down to a temperature below the melting temperature of the hot melt adhesive before the panel and surface covering are brought in the spatially aligned relationship.

8. A method according to claim 7, wherein the layer of hot melt adhesive is provided at a location remote from a production location of the object, wherein the panel provided with the layer of hot melt adhesive is transported to the production location.

9. A method according to claim 8, wherein multiple panels provided with a layer of hot melt adhesive are transported and/or stored while being in a stacked arrangement without a protective foil being present on each layer of hot melt adhesive.

10. A method according to claim 8, wherein the method comprises a step of removing exogenous particles from the surface of the layer of hot melt adhesive before the hot melt adhesive is heated to a temperature above its melting temperature.

11. A method according to claim 1, wherein the panel and/or surface covering are heated before the panel and surface covering are pressed together.

12. A method according to claim 1, wherein the panel is a fibrous material.

13. A method according to claim 12, wherein the fibrous material comprises cellulosic fibres.

14. A method according to claim 13, wherein the fibrous material comprises artificial polymer in addition to the cellulosic fibres.

15. A method according to claim 1, wherein the hot melt adhesive comprises a polyester polymer.

16. A method according to claim 15, wherein the polymer is a condensation polymer.

17. A method according to claim 15, wherein the polymer has a weight averaged molecular weight (Mw) between 15,000 and 30,000 g/mol.

18. A method according to claim 15, wherein the polymer has a crystallinity of between 5 and 40%.

19. A method according to claim 1, wherein for separating the surface covering from the panel, the hot melt adhesive is heated to a temperature above its melting temperature using radiation.

20. A method for producing an object consisting of a panel durably provided with a surface covering, comprising:
providing a layer of hot melt adhesive on the panel,
bringing the panel and the surface covering in a spatially aligned relationship,
heating the hot melt adhesive to a temperature above its melting temperature,
pressing the surface covering against the panel while the hot melt layer is an intermediate layer,
cooling down the hot melt adhesive to a temperature below its melting temperature to form the object.

21. A method according to claim 20, wherein the panel has a surface larger than 0.3 m².

22. A panel, one surface of which is provided with a layer of hot melt adhesive having a melting temperature between 40 and 150° C., wherein the thickness of the layer is 50-400 g/m².
